(19) United States
(12) Patent Application Publication
(10) Pub. No.: US 2011/0094671 A1
(43) Pub. Date: Apr. 28, 2011

(54) METHOD FOR BONDING MEMBERS

(75) Inventors: JIA-PING WANG, Beijing (CN); SHOU-SHAN FAN, Beijing (CN)

(73) Assignees: TSINGHUA UNIVERSITY, Beijing (CN); HON HAI PRECISION INDUSTRY CO., LTD., Tu-Cheng (TW)

(21) Appl. No.: 12/783,496

(22) Filed: May 19, 2010

(30) Foreign Application Priority Data
Oct. 22, 2009 (CN) 200910110311.2

(51) Int. Cl. B32B 37/06

(52) U.S. Cl. 156/272.2

(57) ABSTRACT

A method for bonding members is provided. A first member, a second member and a carbon nanotube structure are provided. The carbon nanotube structure is placed between the first member and the second member. The carbon nanotube structure is energized to a temperature equal to or higher than a melting temperature of the first member or the second member.

### RELATED APPLICATIONS

This application claims all benefits accruing under 35 U.S.C. §119 from China Patent Application No. 200910110311.2, filed on Oct. 22, 2009 in the China Intellectual Property Office, the disclosure of which is incorporated herein by reference.

### BACKGROUND

1. Technical Field

The present disclosure relates to methods for bonding members together, and more particularly, to a method for bonding members together utilizing a carbon nanotube structure.

2. Description of Related Art

In a case where two members are bonded together, an adhesive has often been used. However, the bonding strength is relatively low and takes a long time for the adhesive to harden.

Alternative stronger bonding methods are available; one such method involves using a high level of heat to bond members. This high temperature heat treatment bonding method can overheat some areas of the members and cause deformation or unwanted distortion to the members being bonded together. Therefore, improvement in the art is highly desired.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic process diagram according to one embodiment of a method for bonding members.

FIG. 2 is a Scanning Electron Microscope (SEM) image of a drawn carbon nanotube film.

FIG. 3 is a schematic enlarged view of a carbon nanotube segment in the drawn carbon nanotube film of FIG. 2.

FIG. 4 is an SEM image of a flocculated carbon nanotube film.

FIG. 5 is an SEM image of a pressed carbon nanotube film.

FIG. 6 is an SEM image of an untwisted carbon nanotube wire.

FIG. 7 is an SEM image of a twisted carbon nanotube wire.

FIG. 8 is a schematic view of one embodiment of an untwisted linear carbon nanotube structure.

FIG. 9 is a schematic view of one embodiment of a twisted linear carbon nanotube structure.

FIG. 10 shows an SEM image of a bonding interface of a resulting assembly of the method of FIG. 1.

FIG. 11 is an enlarged view of the bonding interface of FIG. 10.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

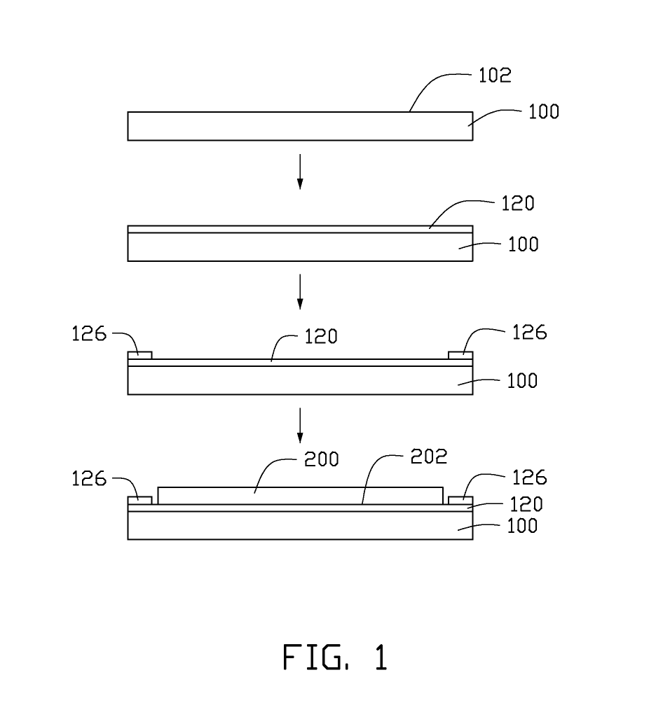

One embodiment of a method for bonding members is illustrated in FIG. 1. The method comprises following steps:

(a) providing a first member 100, a second member 200 and a carbon nanotube structure 120;

(b) placing the carbon nanotube structure 120 between the first member 100 and the second member 200; and

(c) energizing the carbon nanotube structure 120.

In step (a), the first member 100 has a first surface 102, which is needed to be bonded to a second surface 202 of the second member 200.

The shape of the first member 100 is not limited. The first member 100 can be made of insulative materials, such as ceramic, glass, or polymeric materials. Examples of the polymeric materials comprise epoxide resin, bismaleimide resin, cyanate resin, polypropylene, polyethylene, polyvinyl alcohol, polystyrene enol, polycarbonate, and polymethylmethacrylate. In some embodiments, the first member 100 or the second member 200 can be parts of an apparatus or device, and the parts may be coated or may be encapsulated by insulative materials. Examples of a constituent material of the parts include polymeric materials, metals, and ceramic.

The shape and materials of the second member 200 can be the same as or different from those of the first member 100 so long as the second surface 202 can mate with the first surface 102. Examples of the shape of the second member 200 comprise a plate shape, a block shape, or a stick shape. Examples of a constituent material of the second member 200 include insulative materials, such as ceramic, glass, or polymeric materials. Examples of the polymeric materials comprise epoxide resin, bismaleimide resin, cyanate resin, polypropylene, polyethylene, polyvinyl alcohol, polystyrene enol, polycarbonate, or polymethylmethacrylate.

In one embodiment, the first member 100 and the second member 200 are made of materials that have a low melting point, such as lower than 600 centidegree. Then the first member 100 and the second member 200 may be bonded together at a low temperature, and it is possible to further reduce thermal stress, which would be generated on the bonding interface. In one embodiment, the first member 100, and the second member 200 each have a plate shape, and are made of same materials, such as polycarbonate.

The carbon nanotube structure 120 is disposed between and contacts with the first surface 102 and the second surface 202. The carbon nanotube structure 120 can be a free-standing structure, that is, the carbon nanotube structure 120 can be supported by itself and does not require a substrate to lay on and supported thereby.

The carbon nanotube structure 120 includes a plurality of carbon nanotubes combined by van der Waals attractive force therebetween. The carbon nanotube structure 120 can be a substantially pure structure of the carbon nanotubes, with few impurities. The carbon nanotubes can be used to form many different structures and provide a large specific surface area. The heat capacity per unit area of the carbon nanotube structure 120 can be less than 2×10^{-4 J/m}²*K. In one embodiment, the heat capacity per unit area of the carbon nanotube structure 120 is less than or equal to 1.7×10⁻⁶ J/m²*K. As the heat capacity of the carbon nanotube structure 120 is very low, this makes the carbon nanotube structure 120 have a high heating efficiency, a high response heating speed, and accuracy. Further, the carbon nanotubes have a low density, about 1.35 g/cm³, so the carbon nanotube structure 120 is light. As the carbon nanotube has large specific surface area, the carbon nanotube structure 120 with a plurality of carbon nanotubes has large specific surface area. When the specific surface of the carbon nanotube structure 120 is large enough, the carbon nanotube structure 120 is adhesive and can be directly applied to a surface.

The carbon nanotubes in the carbon nanotube structure 120 can be orderly or disorderly arranged. The term ‘disordered carbon nanotube structure’ refers to a structure where the carbon nanotubes are arranged along different directions, and the aligning directions of the carbon nanotubes are random. The number of the carbon nanotubes arranged along each different direction can be almost the same (e.g. uniformly disordered). The disordered carbon nanotube structure can be isotropic, namely the carbon nanotube film has properties identical in all directions of the carbon nanotube film. The carbon nanotubes in the disordered carbon nanotube structure can be entangled with each other.

The carbon nanotube structure 120 including ordered carbon nanotubes can be an ordered carbon nanotube structure. The term ‘ordered carbon nanotube structure’ refers to a structure where the carbon nanotubes are arranged in a consistently systematic manner, e.g., the carbon nanotubes are arranged approximately along a same direction and/or have two or more sections within each of which the carbon nanotubes are arranged approximately along a same direction (different sections can have different directions). The carbon nanotubes in the carbon nanotube structure 120 can be selected from single-walled, double-walled, and/or multi-walled carbon nanotubes.

The carbon nanotube structure 120 can be a carbon nanotube film structure with a thickness ranging from about 0.5 nanometers (nm) to about 1 mm when the first member 100 and the second member 200 each have a plate shape. The carbon nanotube structure 120 can include at least one carbon nanotube film. The carbon nanotube structure 120 can also be at least one linear carbon nanotube structure with a diameter ranging from about 0.5 nm to about 1 mm, when the first member 100 and the second member 200 each have a stick shape or linear shape. The carbon nanotube structure 120 can also be a combination of carbon nanotube film structures and/or linear carbon nanotube structures. In other words, the carbon nanotube structure 120 can be variety of shapes.

### Carbon Nanotube Film Structure

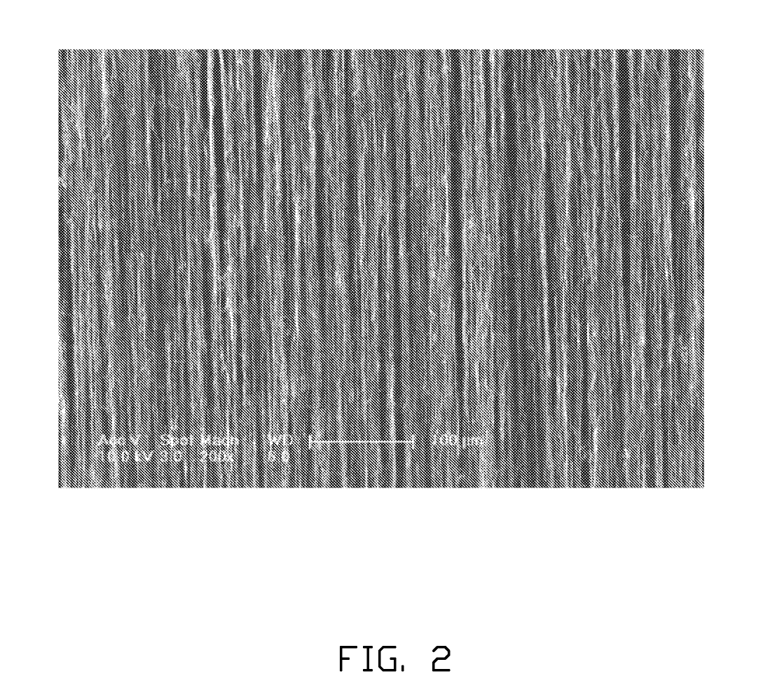

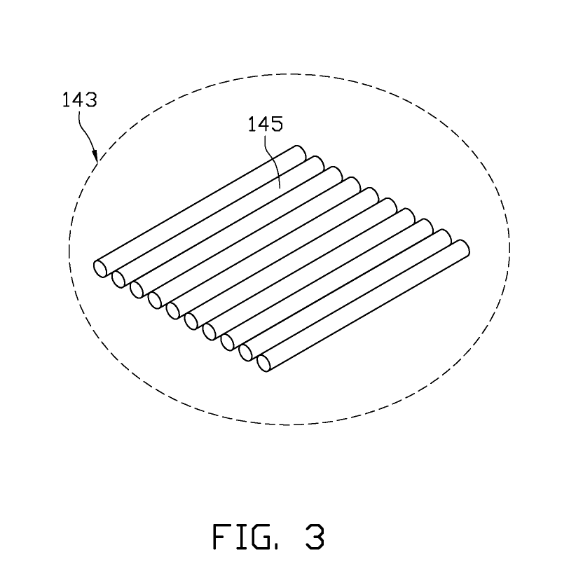

In one embodiment, the carbon nanotube film structure includes at least one drawn carbon nanotube film. A film can be drawn from a carbon nanotube array, to obtain a drawn carbon nanotube film. Examples of drawn carbon nanotube film are taught by U.S. Pat. No. 7,045,108 to Jiang et al., and WO 2007015710 to Zhang et al. The drawn carbon nanotube film includes a plurality of successive and oriented carbon nanotubes, as part of segments, joined end-to-end by van der Waals attractive force therebetween. The drawn carbon nanotube film is a free-standing film. Referring to FIGS. 2 to 3, each drawn carbon nanotube film includes a plurality of successively oriented carbon nanotube segments 143 joined end-to-end by van der Waals attractive force therebetween. Each carbon nanotube segment 143 includes a plurality of carbon nanotubes 145 parallel to each other, and combined by van der Waals attractive force therebetween. As can be seen in FIG. 3, some variations can occur in the drawn carbon nanotube film. The carbon nanotubes 145 in the drawn carbon nanotube film are oriented along a preferred orientation. The carbon nanotube film can be treated with an organic solvent to increase the mechanical strength and toughness of the carbon nanotube film and reduce the coefficient of friction of the carbon nanotube film. The thickness of the carbon nanotube film can range from about 0.5 nm to about 100 μm.

The carbon nanotube film structure can include at least two stacked carbon nanotube films. In other embodiments, the carbon nanotube structure can include two or more coplanar carbon nanotube films, and can include layers of coplanar carbon nanotube films. Additionally, when the carbon nanotubes in the carbon nanotube film are aligned along one preferred orientation (e.g., the drawn carbon nanotube film), an angle can exist between the orientations of carbon nanotubes in adjacent films, whether stacked or adjacent. Adjacent carbon nanotube films can be combined by only the van der Waals attractive force therebetween. An angle between the aligned directions of the carbon nanotubes in two adjacent carbon nanotube films can range from about 0 degrees to about 90 degrees. When the angle between the aligned directions of the carbon nanotubes in adjacent carbon nanotube films is larger than 0 degrees, a microporous structure is defined by the carbon nanotubes. The carbon nanotube structure in an embodiment employing these films will have a plurality of micropores. Stacking the carbon nanotube films will also add to the structural integrity of the carbon nanotube structure.

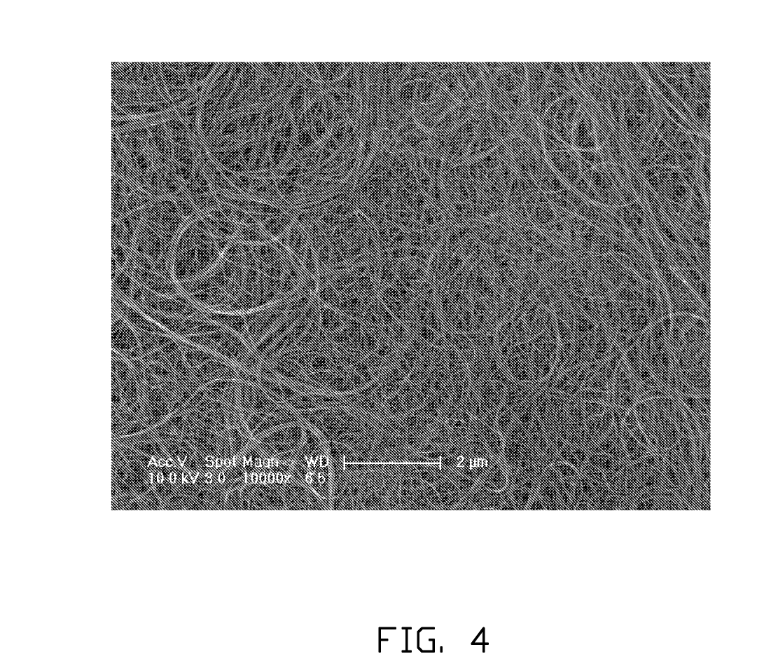

In other embodiments, the carbon nanotube film structure includes a flocculated carbon nanotube film. Referring to FIG. 4, the flocculated carbon nanotube film can include a plurality of long, curved, disordered carbon nanotubes entangled with each other. Further, the flocculated carbon nanotube film can be isotropic. The carbon nanotubes can be substantially uniformly dispersed in the carbon nanotube film. Adjacent carbon nanotubes are acted upon by van der Waals attractive force to obtain an entangled structure with micropores defined therein. It is understood that the flocculated carbon nanotube film is very porous. Sizes of the micropores can be less than 10 μm. The porous nature of the flocculated carbon nanotube film will increase specific surface area of the carbon nanotube structure. Further, due to the carbon nanotubes in the carbon nanotube structure being entangled with each other, the carbon nanotube structure employing the flocculated carbon nanotube film has excellent durability, and can be fashioned into desired shapes with a low risk to the integrity of the carbon nanotube structure. The thickness of the flocculated carbon nanotube film can range from about 0.5 nm to about 1 mm.

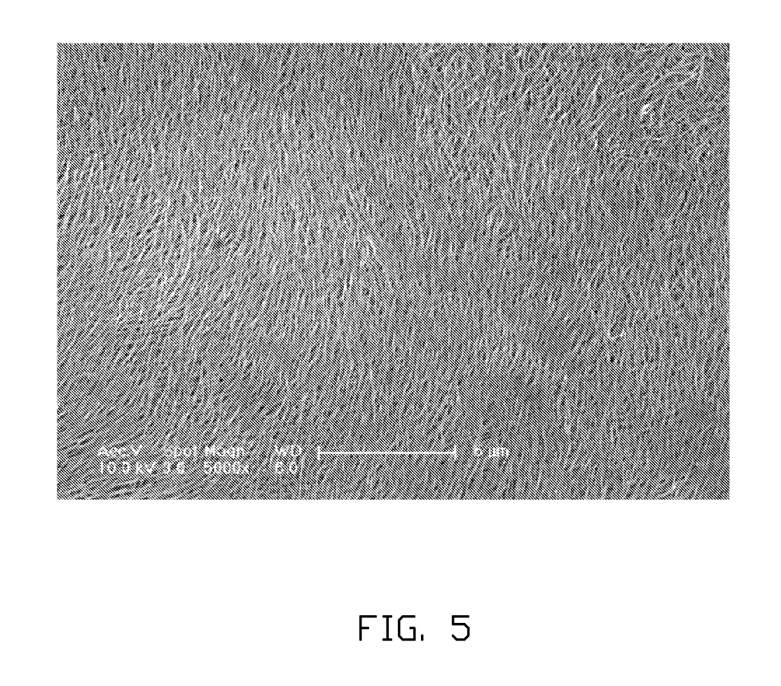

In other embodiments, the carbon nanotube film structure can include at least a pressed carbon nanotube film. Referring to FIG. 5, the pressed carbon nanotube film can be a free-standing carbon nanotube film. The carbon nanotubes in the pressed carbon nanotube film are arranged along a same direction or along different directions. The carbon nanotubes in the pressed carbon nanotube film can rest upon each other. Adjacent carbon nanotubes are attracted to each other and combined by van der Waals attractive force. An angle between a primary alignment direction of the carbon nanotubes and a surface of the pressed carbon nanotube film is about 0 degrees to approximately 15 degrees. The greater the pressure applied, the smaller the angle obtained. When the carbon nanotubes in the pressed carbon nanotube film are arranged along different directions, the carbon nanotube structure can be isotropic. Here, “isotropic” means the carbon nanotube film has properties identical in all directions parallel to a surface of the carbon nanotube film. The thickness of the pressed carbon nanotube film ranges from about 0.5 nm to about 1 mm. Examples of pressed carbon nanotube film are taught by US PGPub. 20080299031A1 to Liu et al.

### Linear Carbon Nanotube Structure

In other embodiments, the linear carbon nanotube structure includes carbon nanotube wires and/or linear carbon nanotube structures.

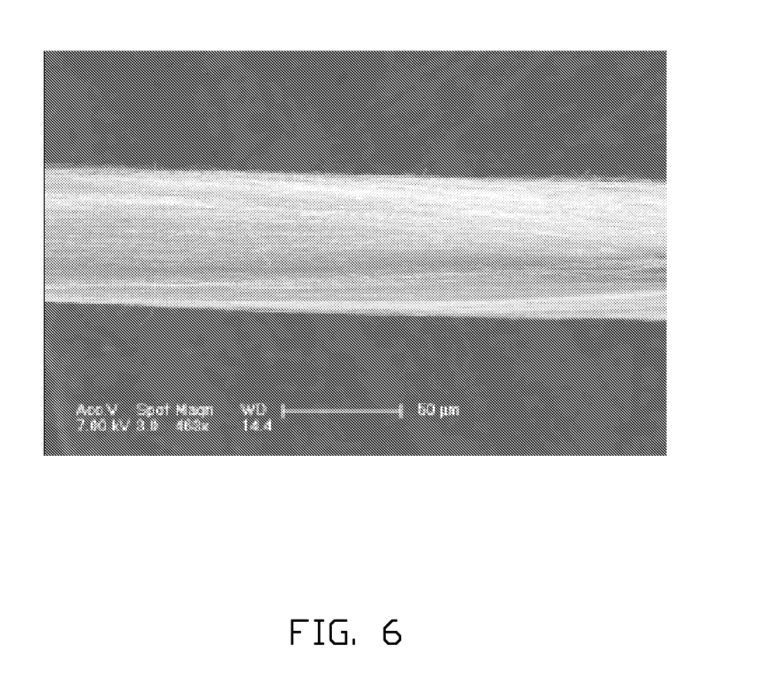

The carbon nanotube wire can be untwisted or twisted. Treating the drawn carbon nanotube film with a volatile organic solvent can obtain the untwisted carbon nanotube wire. In one embodiment, the organic solvent is applied to soak the entire surface of the drawn carbon nanotube film. During the soaking, adjacent parallel carbon nanotubes in the drawn carbon nanotube film will bundle together, due to the surface tension of the organic solvent as it volatilizes, and thus, the drawn carbon nanotube film will be shrunk into an untwisted carbon nanotube wire. Referring to FIG. 6, the untwisted carbon nanotube wire includes a plurality of carbon nanotubes substantially oriented along a same direction (i.e., a direction along the length direction of the untwisted carbon nanotube wire). The carbon nanotubes are parallel to the axis of the untwisted carbon nanotube wire. In one embodiment, the untwisted carbon nanotube wire includes a plurality of successive carbon nanotube segments joined end to end by van der Waals attractive force therebetween. Each carbon nanotube segment includes a plurality of carbon nanotubes substantially parallel to each other, and combined by van der Waals attractive force therebetween. The carbon nanotube segments can vary in width, thickness, uniformity and shape. Length of the untwisted carbon nanotube wire can be arbitrarily set as desired. A diameter of the untwisted carbon nanotube wire ranges from about 0.5 nm to about 100 μm.

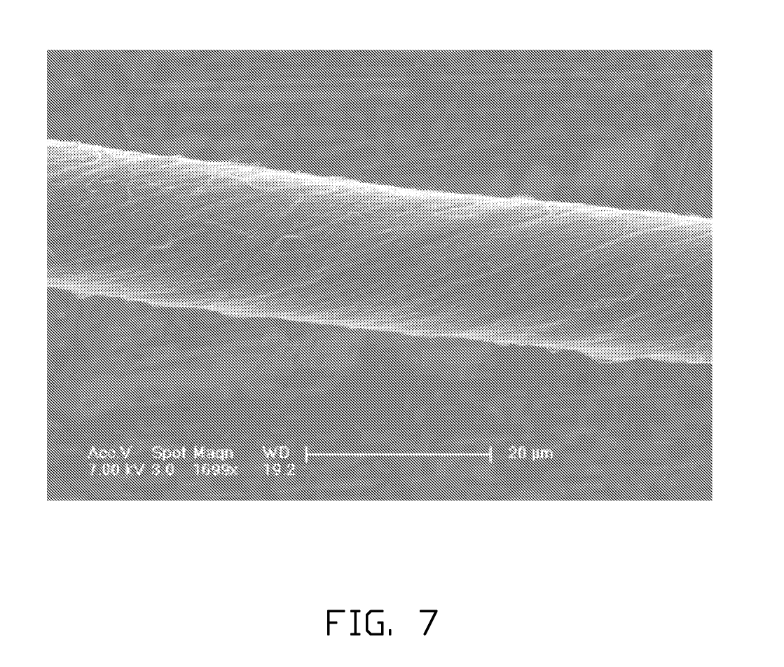

The twisted carbon nanotube wire can be obtained by twisting a drawn carbon nanotube film using a mechanical force to turn the two ends of the drawn carbon nanotube film in opposite directions. Referring to FIG. 7, the twisted carbon nanotube wire includes a plurality of carbon nanotubes helically oriented around an axial direction of the twisted carbon nanotube wire. In one embodiment, the twisted carbon nanotube wire includes a plurality of successive carbon nanotube segments joined end to end by van der Waals attractive force therebetween. Each carbon nanotube segment includes a plurality of carbon nanotubes substantially parallel to each other, and combined by van der Waals attractive force therebetween. Length of the carbon nanotube wire can be set as desired. A diameter of the twisted carbon nanotube wire can be from about 0.5 nm to about 100 μm. Further, the twisted carbon nanotube wire can be treated with a volatile organic solvent after being twisted. After being soaked by the organic solvent, the adjacent paralleled carbon nanotubes in the twisted carbon nanotube wire will bundle together, due to the surface tension of the organic solvent when the organic solvent volatilizing. The specific surface area of the twisted carbon nanotube wire will decrease, while the density and strength of the twisted carbon nanotube wire will be increased.

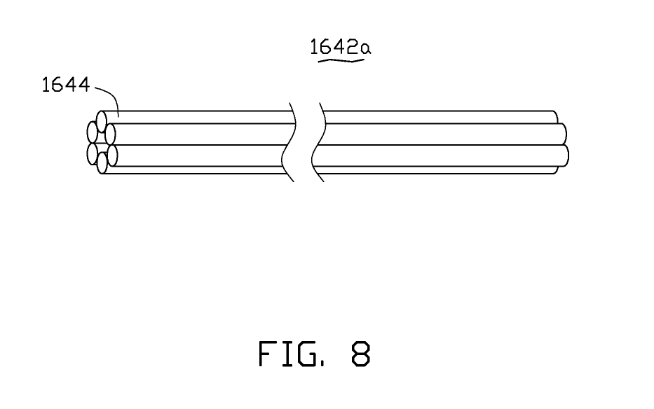

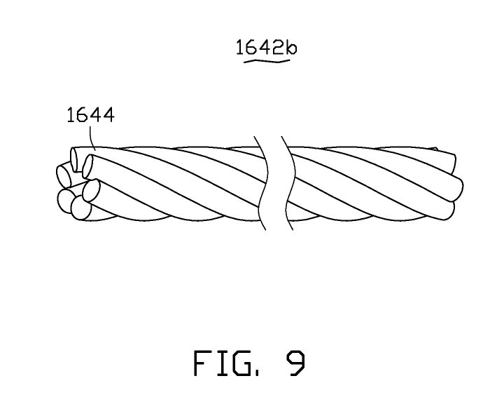

The linear carbon nanotube structure can include one or more carbon nanotube wires. The carbon nanotube wires in the linear carbon nanotube structure can be, twisted and/or untwisted. Referring to FIG. 8, in an untwisted linear carbon nanotube structure 1642a, the carbon nanotube wires 1644 are parallel with each other, and the axes of the carbon nanotube wires 1644 extend along a same direction. Referring to FIG. 9, in a twisted linear carbon nanotube structure 1642b, carbon nanotube wires 1644 are twisted with each other.

In one embodiment, the carbon nanotube structure 120 comprises a plurality of stacked drawn carbon nanotube films. A method for fabricating the carbon nanotube structure 120 includes the steps of: (a) providing an array of carbon nanotubes; (b) pulling out one carbon nanotube film from the array of carbon nanotubes; (c) providing a frame and adhering the carbon nanotube film to the frame; (d) repeating steps (b) and (c), depositing each successive film on a preceding film, thereby achieving at least a two-layer carbon nanotube film; and (e) peeling the carbon nanotube film off the frame to achieve the carbon nanotube structure 120.

In step (b), the carbon nanotube structure 120 is placed between the first surface 102 and the second surface 202. In order to make the first member 100 and the second member 200 be uniformly heat-treated, the carbon nanotube structure 120 is evenly disposed between the first surface 102 and the second surface 202. The first surface 102 and the second surface 202 are attached to opposite surfaces of the carbon nanotube structure 120. As mentioned above, in some embodiments, the carbon nanotube structure 120 is adhesive and can be directly applied to a surface. Thus, when the carbon nanotube structure 120 having adhesiveness is disposed between the first surface 102 and the second surface 202, the first surface 102 and the second surface 202 can be provisionally bonded together by the carbon nanotube structure 120.

Step (b) further comprises a sub-step of placing two electrodes 126 on the carbon nanotube structure 120 before or after the first member 100 and the second member 200 are provisionally held together. The carbon nanotubes of the carbon nanotube structure 120 form at least one electrically conductive path between the two electrodes 126. As shown in FIG. 1, the electrodes 126 are disposed on a surface of the carbon nanotube structure 120 and located at opposite sides of the carbon nanotube structure 120. In one embodiment, the carbon nanotube structure 120 comprises at least one drawn carbon nanotube film. The carbon nanotubes of the drawn carbon nanotube film are oriented along a preferred orientation, from one of the two electrodes 126 to the other one of the two electrodes 126.

The two electrodes 126 are made of electrical conductive materials. The shape of the two electrodes 126 is not limited. Each of the two electrodes 126 can be an electrical conductive film, sheet metal, or wire. In one embodiment, the two electrodes 126 can be electrical conductive films each having a thickness ranging from 0.5 nm to about 100 nm. The electrical conductive film can be made of a plurality of conductive materials such as, metal, alloy, ITO, antimony tin oxide (ATO), conductive silver glue, electro-conductive polymer, or electrical conductive carbon nanotubes. The metal or alloy can be aluminum, copper, tungsten, molybdenum, gold, titanium, neodymium, palladium, cesium, or any combination thereof. The two electrodes 126 can be disposed on the surface of the carbon nanotube structure 120 by sputtering deposition, electrochemical process, direct writing method, or screen printing method.

Further, some of the carbon nanotube structures have large specific surface area and are adhesive in nature, in some embodiments, the two electrodes 126 can be adhered directly to the carbon nanotube structure 120. The two electrodes 126 can also be adhered onto the carbon nanotube structure 120 via conductive adhesives such as conductive silver glues. The conductive adhesive can firmly secure the two electrodes 126 to the carbon nanotube structure 120.

In one embodiment shown in FIG. 1, each of the two electrodes 126 is a film of palladium. The film of palladium has a thickness of about 5 μm. Palladium and carbon nanotubes have good wettability and this contributes to form good electrical contact between the two electrodes 126 and the carbon nanotube structure 120.

In step (c), the carbon nanotube structure 120 is energized to generate heat, which causes the first surface 102 and the second surface 202 to melt or soften. In one embodiment, a voltage is applied to the two electrodes 126 and an electrical current flowing through the carbon nanotube structure 120, making the carbon nanotube structure 120 generate heat between the first surface 102 and the second surface 202, allowing the first surface 102 and the second surface 202 to be uniformly heated since the carbon nanotube structure 120 is evenly disposed between the first surface 102 and the second surface 202.

When the temperatures of the first surface 102 and the second surface 202 reach to their melting points, the first surface 102 and the second surface 202 become soft or molten. During this process, the melting materials of the first surface 102 and the second surface 202 tend to permeate into and through micropores of the carbon nanotube structure 120 to opposite surfaces. As a result, the first surface 102 and the second surface 202 are bonded together.

For example, when the first member 100 and the second member 200 are made of polycarbonate, which has a melting point of about 220 to 230 centidegrees, a voltage can be applied to the carbon nanotube structure 120 until the temperatures of the first surface 102 and the second surface 202 reach or get a little beyond the melting point of about 220 to 230 centidegrees. Then, the first surface 102 and the second surface 202 can be bond together.

It is noteworthy that the voltage needed to be applied to the carbon nanotube structure 120 depends on the materials of the first and second members 100 and 200 and the resistance of the carbon nanotube structure 120. The higher the melting points of the materials of the first and second members 100 and 200, the higher the voltage applied to the carbon nanotube structure 120. The smaller the resistance of the carbon nanotube structure 120, the lower the voltage applied to the carbon nanotube structure 120. The resistance of the carbon nanotube structure 120 is associated with the thickness of the carbon nanotube structure 120. The thickness of the carbon nanotube structure 120 is associated with the number of the layers of the carbon nanotube films. The voltage can be in a range from about 1 volt to 10 volts when the melting points of the materials are not high.

It is noteworthy that step (c) can be carried out in vacuum environment of about 10⁻² Pascals to about 10⁻⁶ Pascals, or in a specific atmosphere of protective gases including nitrogen gas and inert gases. The carbon nanotube structure 120 can generate a lot a heat and reach the temperature of about 2000° C. to bond members which have high melting points when the carbon nanotube structure 120 works in vacuum environment or in a specific atmosphere.

The method further comprises another step (d) of applying pressure to the first member 100 and/or the second member 200 when the first surface 102 and the second surface 202 are in melting or softening state. In this process, the melting materials of the first surface 102 and the second surface 202 are pressed and accelerated to permeate into and go through micropores of the carbon nanotube structure 120 to opposite surfaces. As a result, the first surface 102 and the second surface 202 can be tightly and quickly bond together.

It is noteworthy that the electrodes 126 can be removed by directly removing the electrodes 126 or by cutting the resulting assembly of the first member 100 and the second member 200, after the first member 100 and the second member 200 are bond together.

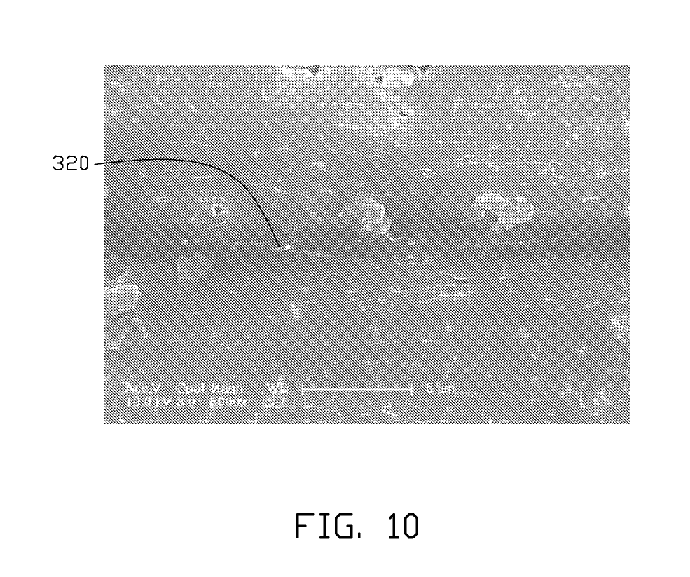

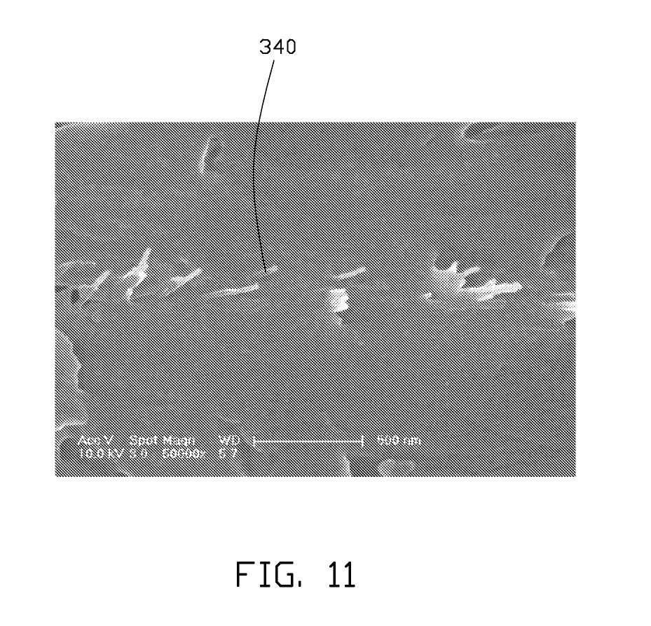

An example of a bonding interface 320 of the first member 100 and the second member 200 is shown in FIGS. 10-11. It is clear that there is no gap in the bonding interface 320 between the first member 100 and the second member 200. The carbon nanotubes 340 are immersed in the first member 100 and the second member, and can strengthen the bonding strength between the members 100 and 200.

It is also clear from FIGS. 10-11 that only the first surface 102 and the second surface 202 contacting the carbon nanotube structure 120 are heated to melt or soften, and other parts of the first member 100 and the second member 200 are not affected. This can reduce energy consumption. Further, when the first member 100 or the second member 200 are parts coated or encapsulated by insulative materials, the parts can be bond together without the parts being heated to melted or soften. Thus, this method can be widely used to bond varieties of members together.

Finally, it is to be understood that the above-described embodiments are intended to illustrate rather than limit the present disclosure. Variations may be made to the embodiments without departing from the spirit of the disclosure as claimed. Elements associated with any of the above embodiments are envisioned to be associated with any other embodiments. The above-described embodiments illustrate the scope of the disclosure but do not restrict the scope of the disclosure.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A method for bonding members comprising the following steps:
(a) providing a first member, a second member and a carbon nanotube structure;
(b) placing the carbon nanotube structure between the first member and the second member; and
(c) energizing the carbon nanotube structure.

2. The method of claim 1, wherein in step (c), the carbon nanotube structure is energized to self-heat to a temperature equal to or higher than a melting temperature of the first member or the second member.

3. The method of claim 2, further comprising a step of applying pressure to the first member, the second member, or both the first and second members when at least a portion of the first member, the second member, or both of the first and second members are in melting or softening state during or after step (c) has been carried out.

4. The method of claim 2, wherein step (c) comprises passing an electric current through the carbon nanotube structure.

5. The method of claim 4, further comprising a step of placing two electrodes on the carbon nanotube structure, wherein the carbon nanotube structure comprises a plurality of carbon nanotubes that forms at least one electrically conductive path between the two electrodes.

6. The method of claim 5, wherein the carbon nanotube structure is a layer-shaped carbon nanotube structure or a linear carbon nanotube structure.

7. The method of claim 6, wherein the layer-shaped carbon nanotube structure comprises at least one drawn carbon nanotube film, at least one flocculated carbon nanotube film, at least one pressed carbon nanotube film, or a combination thereof.

8. The method of claim 7, wherein the layer-shaped carbon nanotube structure comprises at least one drawn carbon nanotube film, the at least one drawn carbon nanotube film includes a plurality of successively oriented carbon nanotube segments joined end-to-end by van der Waals attractive force therebetween, each carbon nanotube segment comprises carbon nanotubes from the plurality of carbon nanotubes parallel to each other, and combined by van der Waals attractive force therebetween, and the plurality of carbon nanotubes of each of the at least one drawn carbon nanotube film are aligned along a direction from the one of the two electrodes to the other one of the two electrodes.

9. The method of claim 8, wherein the layer-shaped carbon nanotube structure comprises a plurality of stacked drawn carbon nanotube films, and the plurality of stacked drawn carbon nanotube films are fabricated according to following steps: (1) providing an array of carbon nanotubes; (2) pulling out a carbon nanotube film from the array of carbon nanotubes; (3) providing a frame and adhering the carbon nanotube film to the frame; (4) repeating steps (2) and (3), depositing each successive film on a preceding film, thereby achieving at least a two-layer carbon nanotube film; and (5) peeling the plurality of stacked drawn carbon nanotube films off the frame to achieve the plurality of stacked drawn carbon nanotube films.

10. The method of claim 6, wherein the linear carbon nanotube structure comprises at least one untwisted carbon nanotube wire or at least one twisted carbon nanotube wire.

11. The method of claim 6, wherein the linear carbon nanotube structure comprises a plurality of carbon nanotube wires, and the plurality of carbon nanotube wires are parallel to each other to form a bundle-like structure or twisted together to form a twisted structure.

12. The method of claim 1, wherein step (c) is carried out in vacuum environment of about 10⁻² Pascals to about 10⁻⁶ Pascals or in a specific atmosphere of protective gases including nitrogen gas and inert gases.

13. The method of claim 1, wherein the first member and the second member are made of insulative materials.

14. The method of claim 1, wherein the first member and the second member are parts of an apparatus or device, and the parts are coated or encapsulated by insulative materials.

15. A method for bonding members comprising the following steps:
(a) providing a first member, a second member and a carbon nanotube structure;
(b) provisionally bonding the first member and the second member together via the adhesiveness of the carbon nanotube structure; and
(c) bonding the first member and the second member together via energizing the carbon nanotube structure.

16. The method of claim 15, wherein step (b) is carried out by placing the carbon nanotube structure between the first member and the second member.

17. The method of claim 15, wherein step (c) is carried out by passing an electric current through the carbon nanotube structure.

18. The method of claim 17, wherein step (c) is carried out in vacuum environment of about 10⁻² Pascals to about 10⁻⁶ Pascals or in a specific atmosphere of protective gases comprising and one or more inert gases.

19. The method of claim 18, further comprising a step of applying pressure to at least one of the first member and the second member.

20. The method of claim 15, wherein the carbon nanotube structure comprises a plurality of micropores having a size less than 10 μm, and in step (c) materials of at least one of the first member and the second member are melted by the carbon nanotube structure, and permeate through the plurality of micropores of the carbon nanotube structure.
